(19) United States
(12) Patent Application Publication
(10) Pub. No.: US 2013/0302517 A1
(43) Pub. Date: Nov. 14, 2013

(54) METHOD FOR IMPROVING THE WEATHERING RESISTANCE OF AUTOMOTIVE COATINGS

(71) Applicants: Jason Michael Murphy, Ypsilanti, MI (US); Cynthia G. Templeman, Ypsilanti, MI (US)

(72) Inventors: Jason Michael Murphy, Ypsilanti, MI (US); Cynthia G. Templeman, Ypsilanti, MI (US)

(73) Assignee: Toyota Motor Engineering & Manufacuring North America, Inc., Erlanger, KY (US)

(21) Appl. No.: 13/470,450

(22) Filed: May 14, 2012

(51) Int. Cl. B05D 5/00

(52) U.S. Cl. 427/160

(57) ABSTRACT

The present disclosed subject matter provides a method for improving the weathering resistance of a coating of paint on a substrate when exposed to adverse environmental conditions. More particularly, the method includes applying a post-production coating to a base coating, where the post-production coating contains a greater concentration of ultraviolet (UV) protectant as compared to the base coating. The UV protectant contained in the post-production coat migrates along a concentration gradient to the base coating, thereby enriching the concentration of UV protectant in the base coating. Although this application will help protect the base paint coating on a variety of substrates from damage due to environmental conditions, the present disclosed subject matter is ideally suited for motor vehicle coating applications.

### FIELD OF THE INVENTION

The present invention is related to a method for improving the weathering resistance of a paint coating, and in particular, to a method of increasing a concentration of UV protectant in a paint coating.

### BACKGROUND OF THE INVENTION

Exterior surfaces are often exposed to environmental conditions that damage a basecoat and/or top coat of a coating structure. Such conditions often include exposure to heat, sunlight and scratches. In order to protect and preserve the aesthetic qualities of a paint finish on an automobile or other vehicle, it is generally known to provide a clear topcoat over the basecoat, so that the basecoat remains unaffected even upon prolonged exposures to the environment or weathering. This type of coating system is typically referred to as basecoat/topcoat or basecoat/clearcoat finish.

The traditional method to prevent basecoat degradation is to add or apply standard automobile waxes to the basecoat/clearcoat finish. However, such waxes degrade over a short duration, usually less than one year, and must be frequently reapplied to maintain optimal performance. As such, a method or process that would improve the weathering resistance of a basecoat/clearcoat finish by increasing UV protection of the basecoat/clearcoat finish would be desirable.

### SUMMARY OF THE INVENTION

The present disclosed subject matter provides a method for improving the weathering resistance of a substrate's base coating of paint when exposed to adverse environmental conditions, for example, the basecoat/topcoat finish of a motor vehicle. The method comprises applying a post-production coating containing an ultraviolet (UV) protectant onto an exterior paint coating which has previously been exposed to UV radiation. The post-production coating contains a higher concentration of UV protectant than the concentration of UV protectant present in the paint coating. As such, a concentration gradient is created from the post-production coating to the paint coating, which allows the UV protectant to migrate down the concentration gradient from the post-production coating, enriching the concentration of UV protectant in the paint coating by at least 2 weight percent (wt %), 5 wt %, or 10 wt %.

The post-production coating is subsequently removed leaving an enriched paint coating with restored weathering resistance. In some instances, the post-production coating can be a wax containing a UV protectant. The UV protectant can be an UVA absorber, an UVB absorber, an UVA-B absorber, a free radical scavenger, a light stabilizer, and combinations thereof. The UV protectant can be a benzophenone, oxalanilide, benzotriazole, hydroxyphenyltriazine, piperidine, and derivatives thereof.

Also provided is a method of restoring weathering resistance to a paint coating after prolonged exposure to sunlight. The method comprises providing an exterior paint coating that has been exposed to sunlight for a prolonged period of time, the exterior paint coating having a first concentration of an ultraviolet (UV) protectant. A wax containing a second concentration of the UV protectant, the first concentration being less than the second concentration, is also provided. The wax is applied to the exterior paint coating such that a concentration gradient is present between the wax and the paint coating, and the UV protectant is allowed to migrate down the concentration gradient from the wax into the external paint coating. The paint coating is thereby enriched with the UV protectant and has a third concentration of the UV protectant that is greater than the first concentration. The wax is removed from the external paint coating leaving an enriched paint coating with restored weathering resistance. This novel technology allows for less frequent applications and greater coating durability.

Although this application will help protect the base paint coating on a variety of substrates from damage due to environmental conditions, the present disclosed subject matter is ideally suited for automobile coating applications.

### BRIEF DESCRIPTION OF THE FIGURES

FIG. 1 is a schematic diagram of a process according to an embodiment of the present invention;

FIG. 2 is a schematic diagram of the concentration profile of UV protectant in the post-production clear coat and substrate's basecoat at time=0;

FIG. 3 is a schematic diagram of the concentration profile of the UV protectant in the post-production clear coat and substrate's basecoat at time>0;

FIG. 4 is the attenuated total reflectance infrared (ATR-IR) spectra of: a paint coated panel without treatment with a UV protectant/wax composition; a paint coated panel with treatment with a UV protectant/wax composition; a wax alone; and a UV protectant alone. FIG. 4 demonstrates that UV protectants migrate from the UV protectant/wax composition to the basecoat.

### DETAILED DESCRIPTION OF THE INVENTION

The present disclosed subject matter provides a method for improving the integrity and longevity of a coating of paint on a substrate when exposed to adverse environmental conditions. More particularly, the method includes applying to a basecoat/topcoat finish, a post-production coating which contains a greater concentration of UV protectant as compared to the basecoat/topcoat finish. The UV protectant in the post-production coating migrates along the concentration gradient into the basecoat/topcoat finish and thereby results in increased UV protectant concentration in the basecoat/topcoat finish. Subsequently, increased protection from weathering is achieved. Although the method disclosed herein will help protect a paint coating on a variety of substrates from damage due to environmental conditions, the present disclosed subject matter is ideally suited for automobile coating applications.

The disclosed subject matter incorporates the use of a post-production coating that contains one or more UV protectant chemicals. In one aspect of the present invention, the post-production coating can have at least one wax and at least one UV protectant. The wax used in this post-production coating can be selected from natural waxes, modified natural waxes, synthetic waxes, or combinations thereof. The UV protectant can be a UVA absorber, a UVB absorber, a UVA&B absorber, free-radical scavengers, light stabilizers, and/or any combination thereof.

It is appreciated that UV protectant chemicals protect surfaces from damage by UV rays by absorbing high-intensity UV rays with excitation to a higher electronic energy state. This energy is quickly converted internally to higher vibrational levels, and is dissipated by photochemical processes such as isomerization, heat release, fluorescence and/or a reaction with other molecules at collision. Examples of families of compounds commonly used as UV absorbing agents include oxalanilide, benzotriazole, hydroxyphenyltriazine, piperidine, para-aminobenzoates, anthranilates, salicylates, cinnamates, pyrrones, benzimidazoles, carbazoles, napholsulfonates, benzophenones, and quinine disulfate. Inorganic UV absorbers include zinc oxide, titanium dioxide, and cerium oxide.

In one embodiment of the present disclosure, the wax or mixture of waxes is combined with one or more UV protectants including UVA absorbers and/or UVB absorbers and/or UVA&B absorbers and/or light stabilizers. There are a number of manufacturers of these UV protectants including but not limited to BASF, Clariant, Creanova, Celenase, and Cytec. The UV absorbers can be benzophenones, oxalanilides, benzotriazoles, and hydroxyphenyltriazines. One example of a UV absorber is hydroxyphenyltriazine, which is sold by BASF as “Tinuvin 400.” An example of hindered amine light stabilizers can be Bis(1,2,2,6,6-pentamethy-4-piperdinyl)-sebacate (CASRN 41556-26-7)), or -(methyl)-8-(1,2,2,6,6-pentamethy-4-30 piperdinyl)-sebacate (CASRN 82919-37-7). Synergistic combinations of UV absorbers and hindered amine light stabilizers are sold by BASF as Tinuvin 5050, 5080, and 5151.

The waxes included in the present invention can be natural substances (animal or vegetable) or synthetic materials solid at ambient temperature (20° C.-25° C.). The wax or waxes constituting the wax mixture can be selected from among Carnauba wax, Candelilla wax and Alfa wax, Montan wax, polyethylene wax, paraffin wax, oxidized paraffin wax, ozokerite, vegetable waxes such as olive tree wax, rice wax, hydrogenated jojoba wax or absolute waxes of flowers such as the essential wax of cassis flower sold by Bertin (France); animal waxes such as beeswax, or modified beeswax (cerabellina); other waxes or primary waxy materials: marine waxes such as that sold by Sophim under the name “M82™” natural or synthetic ceramides or polyethylene 5 waxes.

Synthetic waxes can include silicone waxes such as “Silky Wax 10™” sold by Dow Corning. In addition, synthetic waxes may include clear synthetic waxes including but not limited to “Uniclear 80™” and “Uniclear 80V™” sold by Arizona Chemical Company.

Vegetable waxes of Camauba (extract of Copemrica Cerifera), of Candelilla (extract of Euphobies Cerifera and Pedilantus pavonis) and of Alfa (extract of Stipa tenacissima), are commercial products that can be obtained as known to those skilled in the art.

A mixture of waxes can be combined with one or more additives including, but not limited to, mineral oils such as paraffin oil, fluid silicone oils, silicone resins, amino-functional silicones, fluorinated silanes and silicones, fluorinated oils and waxes, petrolatum and lanolin.

The term “concentration,” as used herein refers to the weight ratio of a substance to fluid volume. The substance may be entirely soluble, partially soluble, or insoluble in the fluid. Thus, the term “concentration gradient” is used herein to refer to a concentration difference between two arbitrary points, divided by the distance between the two points. For example, the concentration gradient referred to herein references the difference in concentration of UV protectant at one point located within the post-production clearcoat and the concentration of UV protectant at a point located in the basecoat. Initially, the concentration of UV protectant in the post-production coating will be greater than that of the automotive base coating. UV protectant chemicals in the post-production coating migrate to the automotive base coating due to the concentration gradient as is known to those skilled in the art. Stated differently, a UV protectant chemical will migrate or diffuse from the post-production coating to the basecoat/topcoat finish due to the negative or downward concentration gradient there between.

According to one method of the present invention, a substrate is coated with a continuous layer of the wax/UV protectant clearcoat. The method of the present invention may be used on automotive surfaces, boats, RVs, motorcycles, and for almost any hard surface found around the home or garage that contains a base coat of paint. One embodiment of the present invention may be applied by paint brush, cloth, pump spray, sponge, or aerosol spray.

After the UV protectants in the post-production coating have migrated to the basecoat/topcoat finish down the concentration gradient, the post-production coating may be removed. In one embodiment of the invention, the basecoat/topcoat finish with the post-production coating therein may be heated to enhance the diffusion of the UV protectant. The post-production coating can be removed by wiping the composition off of the substrate, or by other means known to those skilled in the art.

The present invention relates to a method of protecting a substrate from sources of environmental damage. The sources of environmental damage can include for example UV rays, water spotting, rain and acid rain, inorganic salts, dirt and grime, road tar, bird droppings and other environmental contaminants.

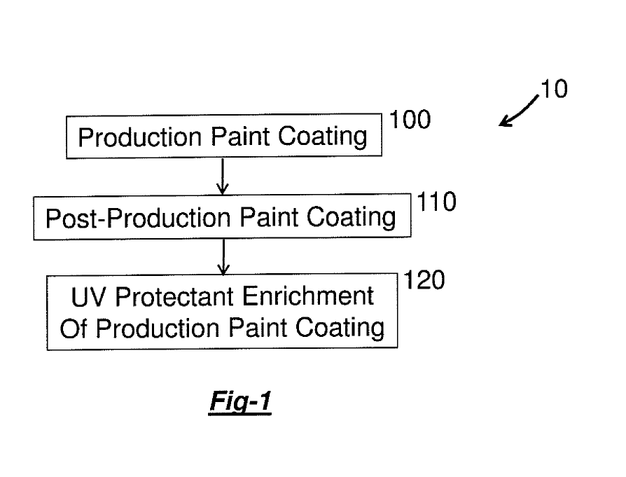

Turning now to FIG. 1, a schematic diagram illustrating a process according to an embodiment of the present invention is shown generally at reference numeral 10. The process 10 includes providing a production coating at step 100, which may or may not contain UV protectants, and depositing a post-production coating onto the base coating at step 110. The post-production coating has a greater concentration of the UV protectant than the production coating such that a concentration gradient is created from the post-production coating to the production coating. The UV protectant migrates down the concentration gradient from the post-production coating into the production coating such that the base coating is enriched with the UV protectant at step 120. The post-production coating can then be removed from the base coating, leaving an enriched production coating with restored weathering resistance. It is appreciated that the production coating can be any type of production coating known to those skilled in the art, illustratively including a simple layer or coating of paint, a basecoat/topcoat finish and the like.

In one aspect of the present disclosure, the concentration of UV protectant in the substrate base coating or paint coating increases by at least 0.1 wt %, at least 0.5 wt %, at least 1 wt %, at least 2 wt %, at least 5 wt %, or by at least 10 wt %.

Enhanced or restored weather resistance can be measured by durability testing such as accelerated weathering testing using Xenon arc chamber (i.e., Atlas Ci5000) or by testing outdoor weathering resistance by sending sample panels (along with control panels) to test yards in Florida, Arizona, or other locations. After specified periods of time or energy exposure, color tone and gloss retention are measured. In addition, visual inspection of the panels is performed to observe defects like cracking, peeling, blistering, chalking, etc.

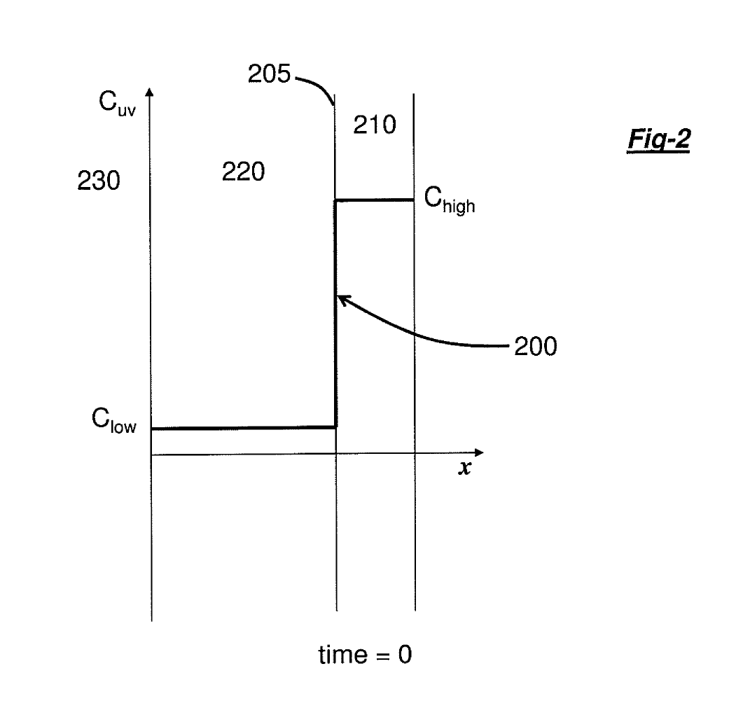

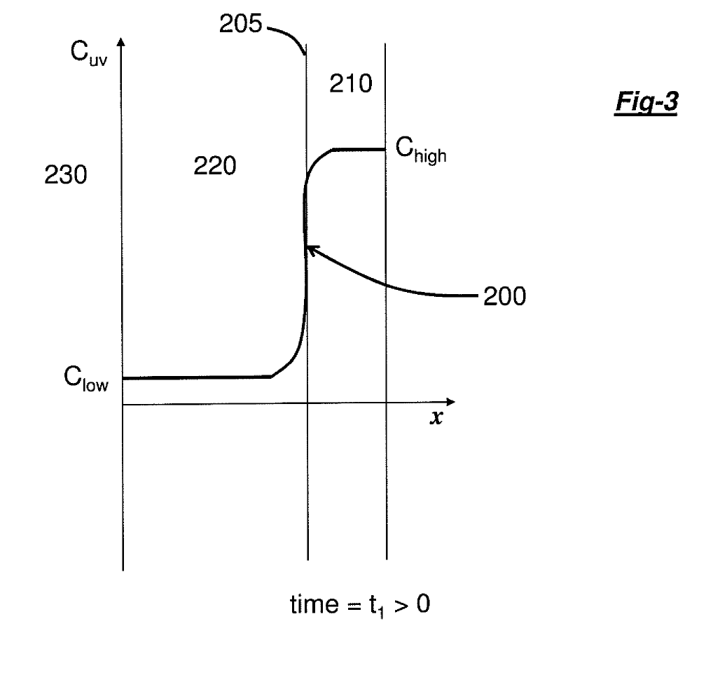

Turning now to FIG. 2, a schematic drawing illustrates the concentration profile 200 of the UV protectant superimposed on a post-production coating 210 that has been applied to a production coating 220 with an interface 205 there between. In addition, the production coating 220 has also been applied to a substrate 230. At time zero, the concentration of the UV protectant in the post-production coating 210 is high, whereas the concentration of the UV protectant in the production coating on the substrate 230 is low. FIG. 3 is a schematic drawing illustrating the concentration of the UV protectant in the post-production coating 210 and production coating 220 on the substrate 230 at some time greater than zero. As shown by the figure, the UV protectant diffuses “down” the concentration gradient 200 from the post-production coating 210, which had a higher concentration at the interface 205 at time zero, to the production coating 220 on the substrate 230, which had a lower concentration at the interface 205 at time zero. In this manner, UV protectant is supplied to the base coating and/or the base coating is enriched with the UV protectant.

The invention is further described by the following examples, which are illustrative of specific modes of practicing the invention and are not intended as limiting the scope of the invention defined in the claims.

### EXAMPLE

Three panels, pretreated with PPG ED6670 electrocoat, were painted with Nippon Paint America MACFLOW O-1830 clearcoat. The paint was cured using a standard bake cycle. Meguiar's Hi-Tech Yellow Wax 26 was heated to 80° C. for approximately 10 minutes and melted. Next, Tinuvin 400 UV-absorber (BASF) was mixed into the wax by hand to give a 13% by weight solution. The wax/Tinuvin 400 mixture was then refrigerated until it hardened, approximately 5 minutes. The bottom half of each of the three painted panels were waxed with the wax/Tinuvin mixture. One panel was placed in a 40° C. oven, the second painted panel was placed in a 30° C. oven, and the third painted panel remained at room temperature, which was approximately 22° C. The panels sat in their respective conditions for approximately 25 minutes, after which the panels were removed from the ovens and the wax was buffed off the panels.

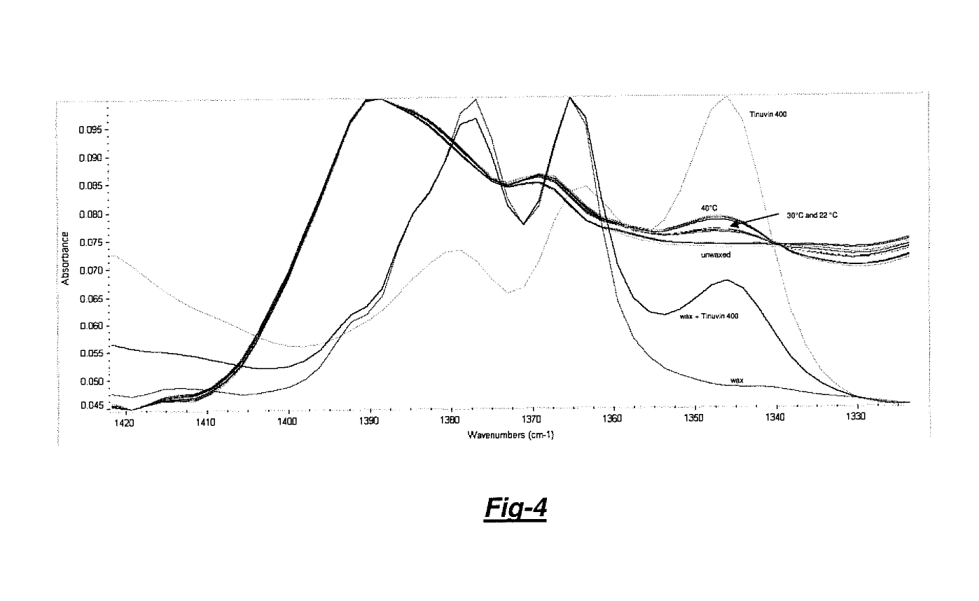

The waxed and unwaxed portions of the panels, the wax alone, the Tinuvin 400 alone, and the wax/Tinuvin-400 composition were analyzed by attenuated total reflectance infrared spectroscopy (ATR-IR). The spectra were baseline corrected and corrected for ATR crystal. The spectra are presented in FIG. 4. The spectra show the presence of Tinuvin-400 remaining in the MACFLOW clearcoat, with the highest concentration of Tinuvin-400 appearing in the panel which was held at 40° C.

The invention is not restricted to the illustrative examples described above. Examples described are not intended to limit the scope of the invention. Changes therein, other combinations of elements, and other uses will occur to those skilled in the art. The scope of the invention is defined by the scope of the claims.

Having described our invention, we claim:

1. A method of restoring weathering resistance to a paint coating, the method comprising:
providing a paint coating;
applying a post-production coating onto the paint coating, the post-production coating containing an ultraviolet (UV) protectant, the post-production coating also having a concentration of the UV protectant greater than the paint coating such that a concentration gradient is created from the post-production coating to the paint coating;
allowing the UV protectant to migrate down the concentration gradient from the post-production coating into the paint coating such that the paint coating is enriched with the UV protectant; and
removing the post-production coating from the paint coating and leaving an enriched paint coating with restored weathering resistance.

2. The method of claim 1, wherein the post-production coating is a wax.

3. The method of claim 1, wherein the UV protectant is selected from the group consisting of an UVA absorber, an UVB absorber, an UVA-B absorber, a free radical scavenger, a light stabilizer, and combinations thereof.

4. The method of claim 3, wherein the UV protectant is selected from the group consisting of benzophenone, oxalani I ide, benzotriazole, hydroxyphenyltri azine, piperidine, and derivatives thereof.

5. The method of claim 1, wherein the concentration of the UV protectant in the paint coating increases by at least 0.1 wt %.

6. The method of claim 5, wherein the concentration of the UV protectant in the paint coating increases by at least 0.5 wt %.

7. The method of claim 6, wherein the concentration of the UV protectant in the paint coating increases by at least 1 wt %.

8. A method of restoring weathering resistance to a paint coating after prolonged exposure to sunlight, the method comprising:
providing an exterior paint coating that has been exposed to sunlight for a prolonged period of time, the exterior paint coating having a first concentration of an ultraviolet (UV) protectant;
providing a wax containing a second concentration of the UV protectant, the first concentration being less than the second concentration;
applying the wax onto the exterior paint coating such that a concentration gradient is present between the wax and the paint coating;
allowing the UV protectant to migrate down the concentration gradient from the wax into the external paint coating such that the paint coating is enriched with the UV protectant and has a third concentration of the UV protectant that is greater than the first concentration; and
removing at least part of the wax from the external paint coating and leaving an enriched paint coating with restored weathering resistance.

9. The method of claim 8, wherein the UV protectant is selected from the group consisting of an UVA absorber, an UVB absorber, an UVA-B absorber, a free radical scavenger, a light stabilizer, and combinations thereof.

10. The method of claim 9, wherein the UV protectant is selected from the group consisting of benzophenone, oxalanilide, benzotriazole, hydroxyphenyltriazine, piperidine, and derivatives thereof

11. The method of claim 8, wherein the third concentration of the UV protectant is greater than the first concentration by at least 0.1 wt %.

12. The method of claim 11, wherein the third concentration of the UV protectant is greater than the first concentration by at least 0.5 wt %.

13. The method of claim 12, wherein the third concentration of the UV protectant is greater than the first concentration by at least 1 wt %.

14. The method of claim 8, wherein the exterior paint coating is on a motor vehicle.
